(19) United States
(12) Patent Application Publication
(10) Pub. No.: US 2007/0160399 A1
(43) Pub. Date: Jul. 12, 2007

(54) Automatic document feeder having a document control roller

(75) Inventors: Thomas Sheng, Hsinchu (TW); Chi-Yao Chen, Nanjhuang Township (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/645,721

(22) Filed: Dec. 27, 2006

(30) Foreign Application Priority Data
Jan. 5, 2006 (TW) 095100414

(51) Int. Cl. G03G 15/00

(52) U.S. Cl. 399/367

(57) ABSTRACT

An automatic document feeder includes a front feeding roller set, a rear feeding roller set, a document control roller and a movement-driving mechanism. The document control roller is disposed between the front feeding roller set and the rear feeding roller set and is located above a scan platen with a gap left therebetween. The front feeding roller set transports a document across the scan platen and then to the rear feeding roller set. The document control roller is rotated to assist in transporting the document and to press the document toward the scan platen. The movement-driving mechanism moves the document control roller such that the gap between the document control roller and the scan platen is adjusted. Thus, a scanning module below the scan platen can scan an image of the document.

### BACKGROUND OF THE INVENTION

1. Field of Invention

The invention relates to an automatic document feeder having a document control roller, and more particularly to an automatic document feeder having a rotatable roller for controlling a document to fall within a depth of focus of a scanning module so that the wear of the roller may be decreased.

2. Related Art

In a conventional automatic document feeder, rollers are often used to transport a document across a scan platen so that a scanning module disposed below the scan platen can scan an image of the document. The scan quality of the document image relates to a depth of focus of the scanning module. The greater depth of focus allows the transported document not to be in contact with the scan platen, while the smaller depth of focus does not allow the transported document to separate from the scan platen.

When the document is transported across the scan platen, a conventional scanner provides a roller to contact the scan platen in order to control the document to fall within the depth of focus of the scanning module effectively. When the document has not been transported across the scan platen, the roller is in sliding friction contact with the scan platen. When the document is being transported across the scan platen, the roller and the document are in rolling friction contact with each other, and the document and the scan platen are in sliding friction contact with each other. In this case, the wear of the roller and that of the scan platen become very large, and the scan quality tends to be influenced. In addition, when the thickness of the document becomes larger, the document may not enter a passage between the roller and the scan platen, and the transporting procedure cannot be completed. Thus, the prior art usually provides an elastic force to push the document toward the scan platen as much as it can in order to control the transported document to fall within the depth of focus of the scanning module. Alternatively, some scan platen is hollow without any glass. In this case, the scanning module is in friction contact with the roller. So, the prior art speeds up the wear between the roller and the scan platen or between the roller and the scanning module, thereby influencing the subsequent image scanning quality.

### SUMMARY OF TH INVENTION

It is therefore an object of the invention to provide an automatic document feeder having a rotatable roller for controlling a document to fall within a depth of focus of a scanning module so that the wear of the rotatable roller may be decreased.

To achieve the above-identified object, the invention provides an automatic document feeder including a front feeding roller set, a rear feeding roller set, a document control roller and a movement-driving mechanism. The document control roller is disposed between the front feeding roller set and the rear feeding roller set and above or on one side of a scan platen, and is separated from the scan platen by a gap. The front feeding roller set transports a document across the scan platen and then to the rear feeding roller set. The document control roller is rotated to assist in transporting the document and to press the document toward the scan platen. The document control roller may be moved by the movement-driving mechanism so that the gap between the document control roller and the scan platen may be adjusted.

Thus, a scanning module disposed below or on the other side of the scan platen may scan an image of the document.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a partially schematic illustration showing an automatic document feeder according to a first embodiment of the invention; and

FIG. 2 is a partially schematic illustration showing an automatic document feeder according to a second embodiment of the invention.

### DETAILED DESCRIPTION OF THE INVENTION

The present invention will be apparent from the following detailed description, which proceeds with reference to the accompanying drawings, wherein the same references relate to the same elements.

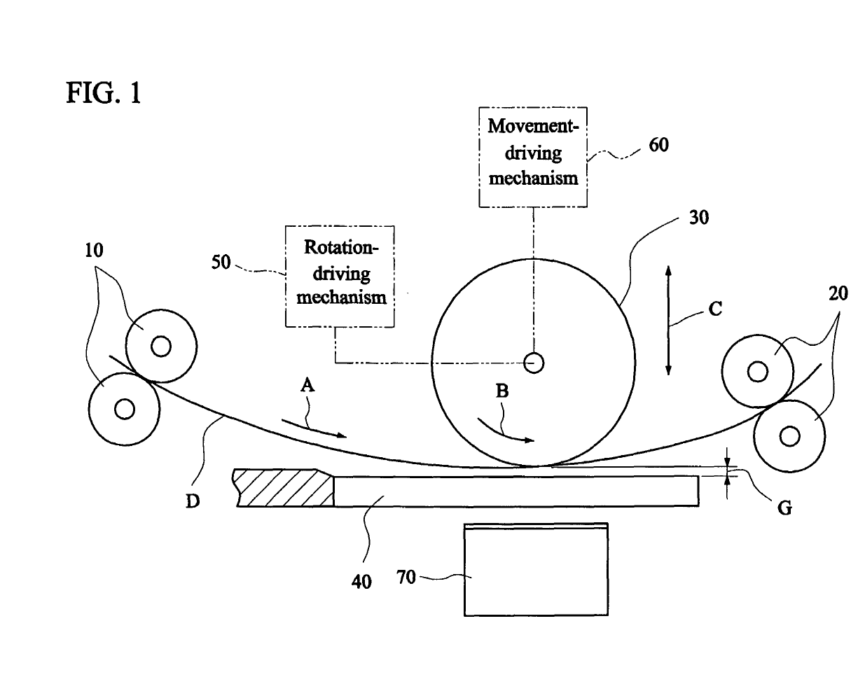

FIG. 1 is a partially schematic illustration showing an automatic document feeder according to a first embodiment of the invention. Referring to FIG. 1, the automatic document feeder of the invention includes a front feeding roller set 10, a rear feeding roller set 20, a document control roller 30 and a movement-driving mechanism 60. The document control roller 30 may be made of rubber or other materials. The document control roller 30 is disposed between the front feeding roller set 10 and the rear feeding roller set 20 and above or on one side of a scan platen 40, and is separated from the scan platen 40 by a gap G. The front feeding roller set 10 transports a document D across the scan platen 40 and then to the rear feeding roller set 20, as indicated by the direction of the arrow A. When the document is being transported, the document control roller 30 is rotated in the direction of the arrow B to assist in transporting the document D and to press the document D toward the scan platen 40. Thus, a scanning module 70 below or on the other side of the scan platen 40 can scan an image of the document D.

The scanning module 70 may be a charge coupled device (CCD) scanning module or a contact image sensor (CIS) scanning module. The scan platen 40 is made of a transparent material such as a glass material or an acrylic material. The scan platen 40 may also have a through hole through which the light ray may pass directly. Alternatively, the scan platen 40 may have an opening, through which the light ray coming from the document D may pass directly and then reach the scanning module 70.

The automatic document feeder of the invention may be integrally formed together with the scan platen 40 and the scanning module 70 to form a so-called sheet-fed scanner. Alternatively, the automatic document feeder of the invention may be separated from a unit containing the scan platen 40 and the scanning module 70, and may be regarded as a document feeding module disposed on a flatbed scanner.

In order to reduce the wear of each of the document control roller 30, the scan platen 40 and the scanning module 70 and to adapt the automatic document feeder to the transportation of the documents with various thicknesses, the document control roller 30 has to be separated from the scan platen 40 or the scanning module 70. Thus, in this embodiment, the document control roller 30 may be moved by the movement-driving mechanism 60 substantially along the direction of the arrow C so that the gap G between the document control roller 30 and the scan platen 40 can be adjusted. The movement-driving mechanism 60 may be driven by the electric power through a device such as a motor or a solenoid, or may be driven by the manpower through an actuating link. Thus, the user may adjust the gap G through the actuating link according to the thickness of the document.

In order to rotate the document control roller 30, the automatic document feeder of this embodiment further includes a rotation-driving mechanism 50 for rotating the document control roller 30. The rotation-driving mechanism 50 may be composed of a belt and pulleys, composed of a plurality of gears, composed of a chain and sprockets, or any other mechanism. The rotation-driving mechanism 50, the front feeding roller set 10 and the rear feeding roller set 20 are driven by one single power source. Alternatively, the power source of the rotation-driving mechanism 50 may be independent of the power source of the front feeding roller set 10 and the rear feeding roller set 20.

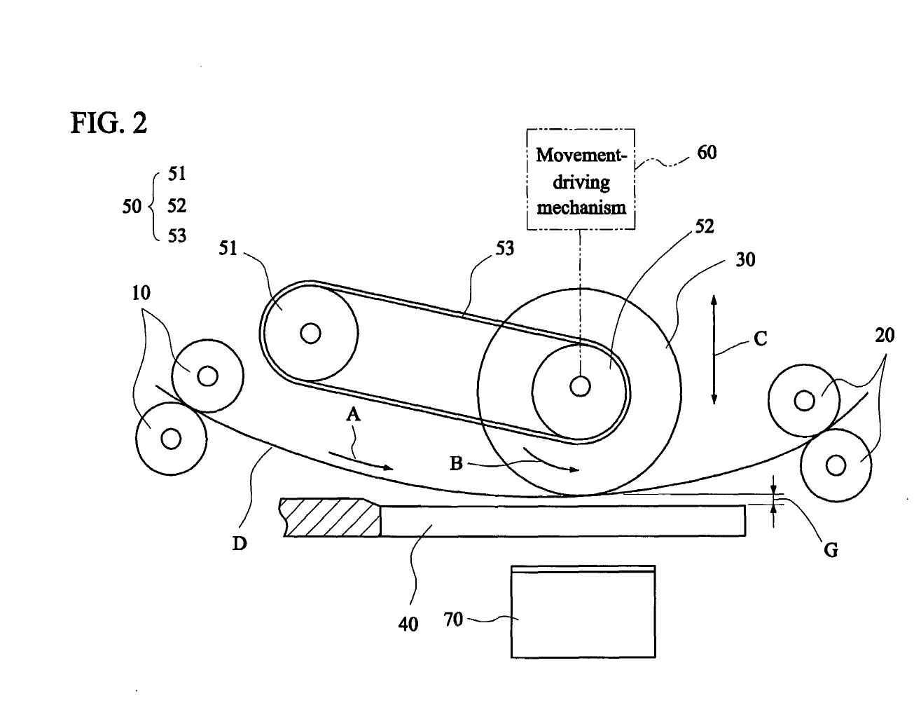

FIG. 2 is a partially schematic illustration showing an automatic document feeder according to a second embodiment of the invention. As shown in FIG. 2, this embodiment is similar to the first embodiment except that the rotation-driving mechanism 50 includes a driving pulley 51, a driven pulley 52 and a belt 53. The driven pulley 52 is coaxially mounted on the document control roller 30. The belt 53 connects the driving pulley 51 with the driven pulley 52, and is driven by the driving pulley 51 to rotate the document control roller 30. It is to be noted that the driving pulley 51 and the driven pulley 52 may be pivoted on two ends of a rocker arm (not shown). The function of the movement-driving mechanism 60 can be achieved by swinging the rocker arm slightly.

According to the automatic document feeder of the invention, the document control roller 30 does not contact the scan platen 40, or the document control roller 30 does not contact the scanning module 70 when the scan platen 40 has the opening. In addition, the document control roller 30 and the document are almost in rolling contact with each other. So, the document control roller 30, the scan platen 40 and the scanning module 70 cannot be greatly worn so that the image scanning quality cannot be deteriorated rapidly due to the long term of use. In addition, because the gap G is adjustable, the user or the overall system can properly adjust the gap G according to the thickness of the document so that the document can be transported more smoothly.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An automatic document feeder, comprising:
a front feeding roller set;
a rear feeding roller set;
a document control roller, which is disposed between the front feeding roller set and the rear feeding roller set and on one side of a scan platen and is separated from the scan platen by a gap, wherein the front feeding roller set transports a document across the scan platen and then to the rear feeding roller set, and the document control roller is rotated to assist in transporting the document and to press the document toward the scan platen; and
a movement-driving mechanism for moving the document control roller to adjust the gap between the document control roller and the scan platen.

2. The feeder according to claim 1, wherein the document control roller is rotated to assist in transporting the document and to press the document toward the scan platen such that a scanning module disposed on the other side of the scan platen scans an image of the document.

3. The feeder according to claim 2, wherein the scan platen has an opening, and a light ray coming from the document directly passes the opening and reaches the scanning module.

4. The feeder according to claim 1, further comprising:
a rotation-driving mechanism for rotating the document control roller.

5. The feeder according to claim 4, wherein the rotation-driving mechanism comprising:
a driving pulley;
a driven pulley coaxially mounted on the document control roller;
a belt, which connects the driving pulley with the driven pulley, and is driven by the driving pulley to rotate the document control roller.

6. The feeder according to claim 4, wherein the rotation-driving mechanism comprises a gear.

7. The feeder according to claim 4, wherein the rotation-driving mechanism, the front feeding roller set and the rear feeding roller set are driven by the same power source.

8. The feeder according to claim 1, wherein the document control roller is made of rubber.

9. The feeder according to claim 1, wherein the movement-driving mechanism is driven by electric power or man power.

10. The feeder according to claim 1, wherein the scan platen is made of a glass material or an acrylic material.

11. The feeder according to claim 1, wherein the scan platen has a through hole.
